(19) United States
(12) Patent Application Publication
(10) Pub. No.: US 2009/0049070 A1
(43) Pub. Date: Feb. 19, 2009

(54) Web-based social network badges

(76) Inventor: Arieh Steinberg, Menlo Park, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/893,493

(22) Filed: Aug. 15, 2007

(51) Int. Cl. G06F 7/00

(52) U.S. Cl. 707/101

(57) ABSTRACT

Web-based social network badges according to various exemplary embodiments are customizable displays which allow computer users who are members of a web-based social network to share personal information on various third-party web sites. A template is used for selecting user information from a profile on the social network to appear on the badge. A dynamic script accesses and renders the selected user information on the badge, and a URL is used to embed the badge as an image-based display on the third-party web site. The badge is dynamically updated when a user updates the user information. Additonally, the badge on the third-party web site includes a link to the profile stored on the server for the web-based social network.

### CROSS-REFERENCE TO RELATED APPLICATIONS

This application is related to:

U.S. patent application Ser. No. 11/639,655 filed on Dec. 14, 2006, entitled “Systems and Methods for Social Mapping,” which in turn claims the benefit and priority of U.S. Provisional Patent Application Ser. No. 60/750,844 filed on Dec. 14, 2005, entitled “Systems and Methods for Social Mapping,”

U.S. patent application Ser. No. 11/646,206 filed on Dec. 26, 2006, entitled “Systems and Methods for Social Timeline,” which in turns claims the benefit and priority of U.S. Provisional Patent Application Ser. No. 60/753,810 filed on Dec. 23, 2005, entitled “Systems and Methods for Social Timeline,”

U.S. patent application Ser. No. 11/493,291 filed on Jul. 25, 2006, entitled “Systems and Methods for Dynamically Generating a Privacy Summary,”

U.S. patent application Ser. No. 11/502,757 filed on Aug. 11, 2006, entitled “Systems and Methods for Generating Dynamic Relationship-Based Content Personalized for Members of a Web-Based Social Network,”

U.S. patent application Ser. No. 11/503,093 filed on Aug. 11, 2006, entitled “Systems and Methods for Measuring User Affinity in a Social Network Environment,”

U.S. patent application Ser. No. 11/503,037 filed on Aug. 11, 2006, entitled “Systems and Methods for Providing Dynamically Selected Media Content to a User of an Electronic Device in a Social Network Environment,”

U.S. patent application Ser. No. 11/503,242 filed on Aug. 11, 2006, entitled “System and Method for Dynamically Providing a News Feed About a User of a Social Network,”

U.S. patent application Ser. No. 11/580,210 filed on Oct. 11, 2006, entitled “System and Method for Tagging Digital Media,” and

U.S. patent application Ser. No. 11/713,455 filed on Feb. 28, 2007, entitled “Systems and Methods for Automatically Locating Web-Based Social Network Members.”

The disclosures of all of the above U.S. patent applications are incorporated by reference herein.

### FIELD OF THE INVENTION

The present invention relates generally to web-based social networks, and more particularly to web-based social network badges.

### DESCRIPTION OF RELATED ART

Conventionally, when a computer user wishes to provide identifying information such as a name and email address on a web site, the user must manually enter the identifying information. The identifying information, however, may be improperly entered by the user. Alternatively, an automated approach to having the same information entered may not be compatible with the underlying architecture and/or programming of the web site receiving the information. Regardless of the approach taken, the information may become outdated should the computer user move, change jobs, change email addresses, etc.

### SUMMARY OF THE INVENTION

Web-based social network badges according to various exemplary embodiments are customizable displays which allow computer users who are members of a web-based social network to share personal information on various third-party web sites. A template is used for selecting user information from a profile on the social network to appear on the badge. A dynamic script accesses and renders the selected user information on the badge, and a Uniform Resource Locator (“URL”) is used to embed the badge as an image-based display on a third-party web site. The badge is dynamically updated when a user updates the user information. Additionally, the badge on the third-party web site includes a link to the profile stored on the server for the web-based social network.

Exemplary methods for generating a web-based social network badge include storing a profile on a server for a web-based social network, the server receiving a selection of an item of user information from the profile to appear on the badge, and the server accessing and rendering the selected user information on the badge. A URL is provided for embedding the badge as an image-based display on the third-party web site.

### BRIEF DESCRIPTION OF THE DRAWINGS

FIG. 1 shows a screenshot of a web-based social network profile according to one exemplary embodiment;

FIG. 2 shows a screenshot of an exemplary badge selection screen;

FIG. 3 shows a screenshot of an exemplary badge creation screen;

FIG. 4 shows a screenshot of an exemplary badge having a URL for copying and pasting the badge onto a third-party web site;

FIG. 5 shows a third-party web site with an exemplary badge embedded on the site; and

FIG. 6 is a flow chart of an exemplary process for generating a web-based social network badge.

### DETAILED DESCRIPTION

Web-based social network badges according to various exemplary embodiments are customizable displays which allow computer users who are members of a web-based social network to share personal information on various third-party web sites. A badge appears as an image on the third-party web site and is therefore readily compatible with most third-party web sites. Because the badge is written in a dynamic scripting language, the badge may be dynamically updated when a member makes a change to his or her personal profile on the web-based social network. Further, multiple badges on numerous third-party web sites may be simultaneously maintained and updated each time the member makes a particular change to the personal profile. In a further embodiment, a computer user viewing a badge on a third party web site may activate a link on the badge to be automatically directed to the member's personal profile on the social network.

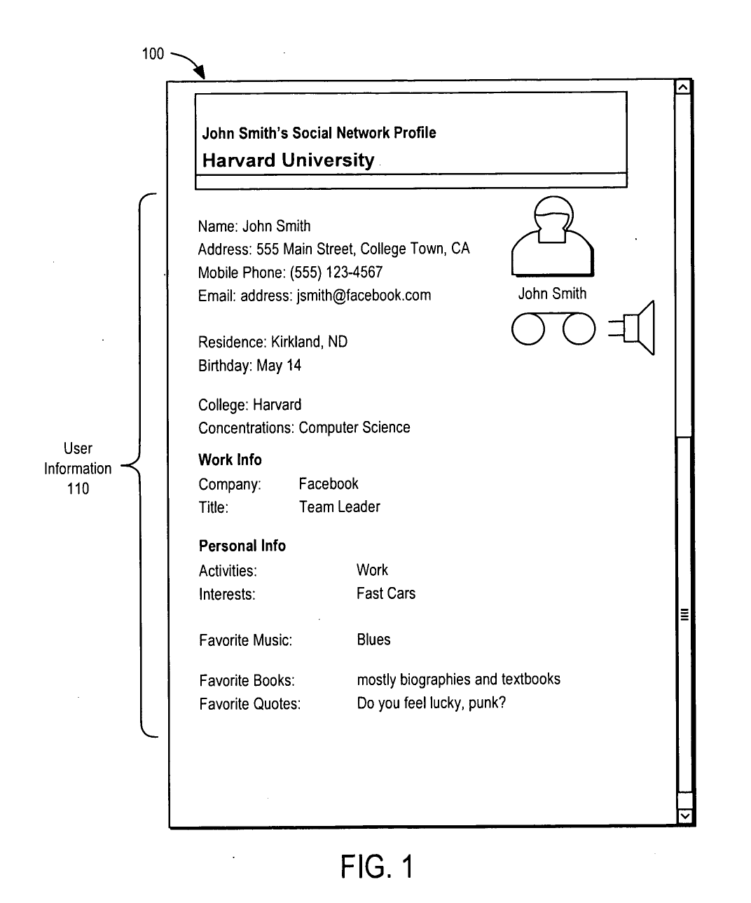

FIG. 1 shows a screenshot of an exemplary web-based social network profile 100. The exemplary web-based social network profile 100 includes various items of user information 110 that may also appear on a badge. The user information in the social network profile 100 may be entered, selected and/or uploaded by a particular user who is a member of the web-based social network. In the social network profile 100, the member is John Smith of Harvard University. User information in the social network profile 100 may include a member's name, profile picture, mobile number, email address, audio, visual, and/or audiovisual information, residence, birthday, college, concentration or major, work information, and/or other information. The social network profile 100 may also include user information such as other forms of digital data, including pictorial, photographic, image form, text files, and/or other variations and combinations thereof. According to a further embodiment, the social network profile 100 may be subject to various privacy settings as determined and set by the member. Privacy settings may limit the computer users that may view the profile 100 and/or may limit what parts of the profile 100 the computer users may view. According to a further embodiment, a public profile may be generated that displays a subset of the user information in the social network profile 100 as selected by the member for viewing by anyone accessing the public profile by computer.

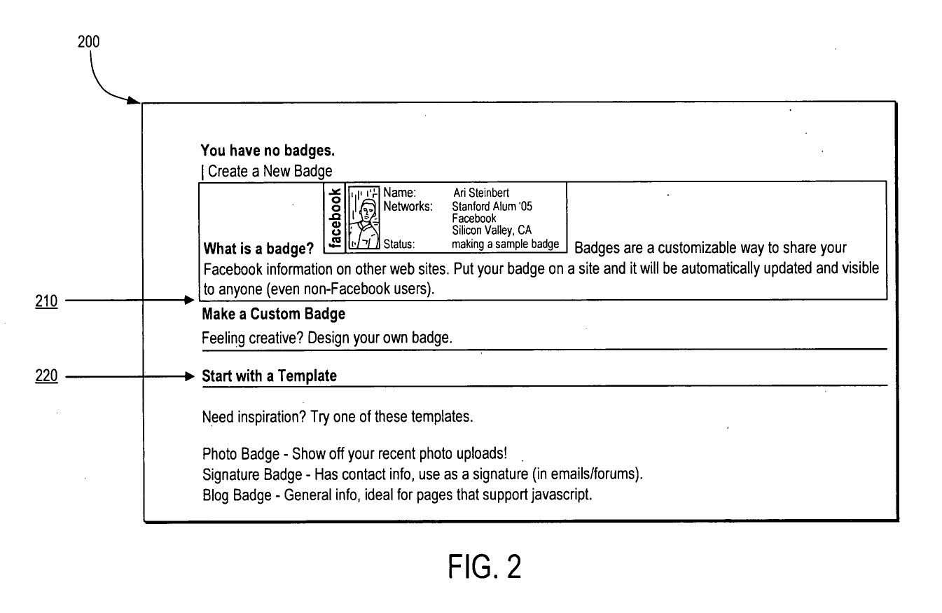

FIG. 2 shows a screenshot of an exemplary badge selection screen 200. The exemplary badge selection screen 200 includes a custom badge template selection 210, and pre-designed badge template selections 220. A member of a web-based social network who has a social network profile, such as the exemplary social network profile 100 (FIG. 1), may access the badge selection screen 200 to select or create a badge template. As will be described herein, after the member creates or selects a badge template, they may select items of user information from the social network profile 100 to be included on the badge.

In the exemplary badge selection screen 200, the member of the web-based social network may use the custom badge template selection 210 to create a custom badge template. Generally, the custom badge template selection 210 allows a member to create a custom badge template by presenting the member with a variety of sizes and shapes of badge templates. The custom badge template selection 210 may also allow a member to select from a variety of font sizes and font positions for some or all of the textual information appearing on the custom badge template. Alternatively, the member may use the pre-designed badge template selections 220 to select a badge template such as a photo badge template, a signature badge template and/or a blog badge template. For example, the photo badge template may be used to display one or more photographs recently uploaded by the member to the member's profile. Alternatively, the signature badge template may be used to display information such as name, email address, and/or mobile number to be included as part of a signature badge for posting by the member on emails and/or in chat rooms. A blog badge template may be used to display a wide variety of information and may be readily posted by the member on third party web sites that are supported by javascript.

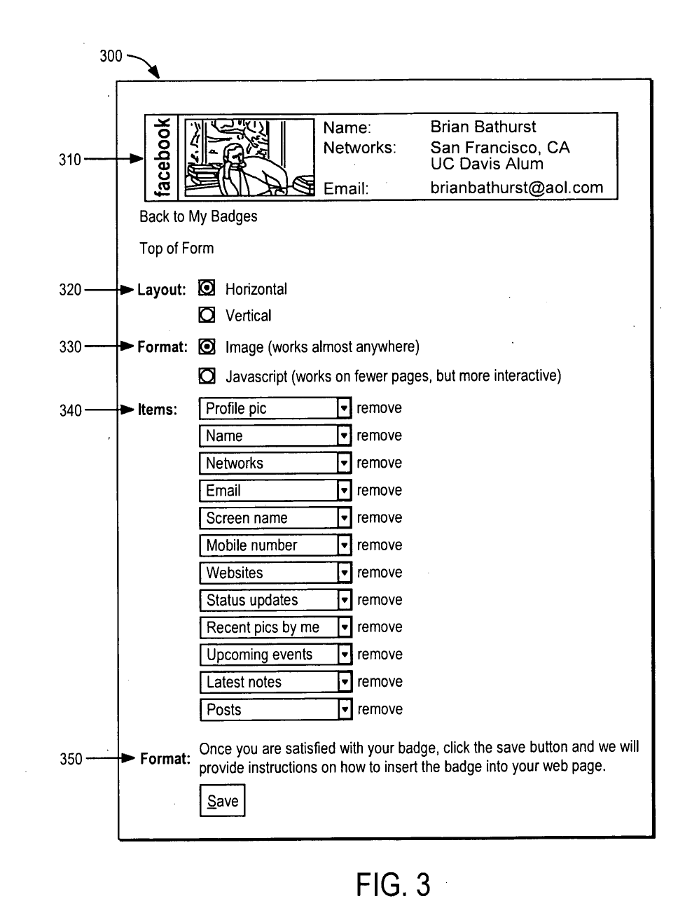

FIG. 3 shows a screenshot of an exemplary badge creation screen 300. The exemplary badge creation screen 300 includes a badge preview 310, layout selections 320, format selections 330, item selections 340 and format save selection 350. A member of a web-based social network who has created or selected a badge template using a badge selection screen such as the exemplary badge selection screen 200 (FIG. 2), may use the exemplary badge creation screen 300 to add further embellishments to the badge, including the selection of various items of user information from the social network profile 100 (FIG. 1) to be displayed on the badge.

According to one exemplary embodiment, the badge preview 310 allows the member to view the result of selections made with the badge creation screen 300. The layout selections 320 allow the member to horizontally or vertically arrange information appearing on the badge. For example, if the member selects to vertically arrange information appearing on the badge, the badge preview 310 will display the badge with the profile picture on top of the text information (instead of horizontally aligned next to the text information, as illustrated in the badge preview 310).

The format selections 330, according to one embodiment, allow the member to select whether they wish for their badge to appear on a third party web site as an image or in javascript format. The image format is compatible with a wide variety of third party web sites. The javascript format works on fewer third party web sites, but allows the computer user viewing the badge more opportunities to interact with various portions of the badge.

According to one exemplary embodiment, the items selection 340 allows the member to select various items of user information from the web-based social network profile 100 to appear on the badge. For example, the member may use the items selection 340 to select the member's profile picture for a badge. Other user information that may be selected for the badge may include the member's name, networks, email address, screen name, mobile number, web sites, status updates, recently taken pictures, upcoming events, latest notes and/or posts. A dynamic script accesses the selected user information and renders it for display on the badge preview 310. After the member has finished making selections with the exemplary badge creation screen 300, the member may use the format save selection 350 to save the badge.

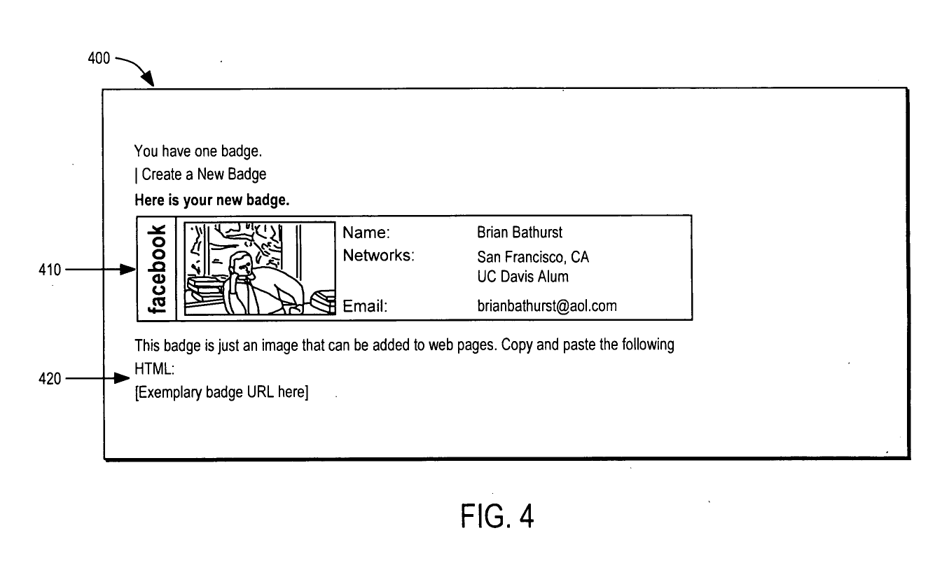

FIG. 4 shows a screenshot 400 of an exemplary badge 410 having a Uniform Resource Locator (“URL”) 420. For example, http://www.uspto.gov/ may be a URL. According to one exemplary method, after a member of a web-based social network has saved a badge using a format save selection such as the exemplary format save selection 350 (FIG. 3), the member may use the URL 420 to embed the badge 410 onto a third-party web site. Specifically, the member may copy and paste the URL onto the third-party web site. The badge 410 may appear on the third-party website as an image-based display. The image-based display may be dynamically updated each time the member updates their web-based social network profile 100 (FIG. 1). For instance, if the member used items selection 340 (FIG. 3) to select “Email” to appear on their badge 410, and the member later changes their email address on their web-based social network profile 100, the badge 410 will be dynamically updated to reflect the new email address.

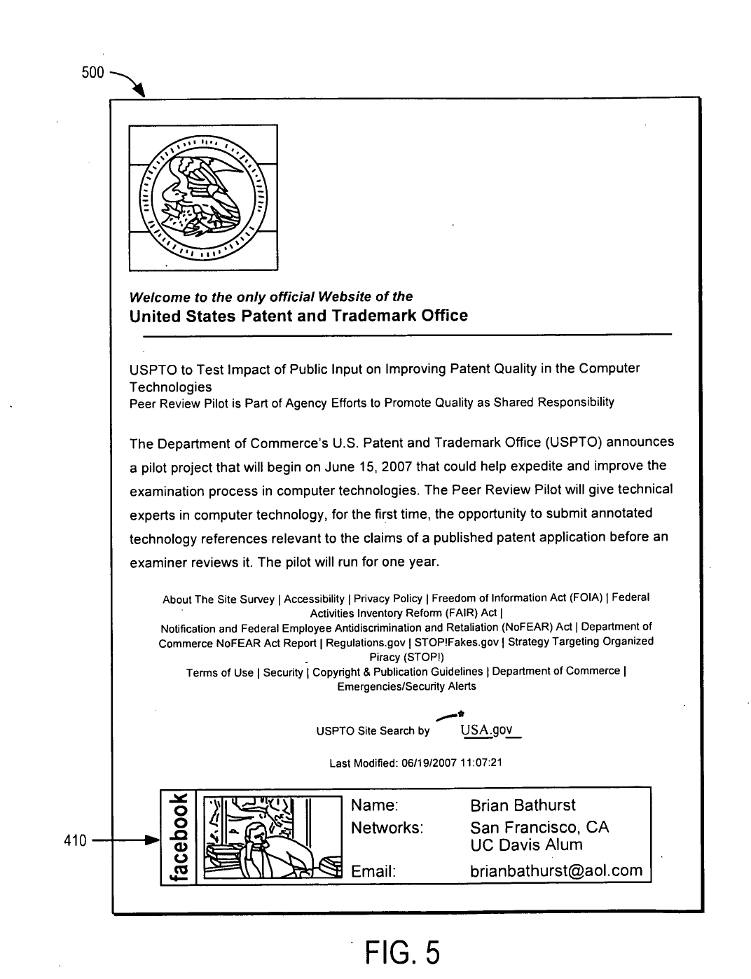

FIG. 5 shows a third-party web site 500 with an exemplary embedded badge 410 (FIG. 4). According to various exemplary embodiments, a member may use the URL 420 (FIG. 4) to embed the badge 410 as an image-based display on a third-party web site. In some cases, the member may need authorization or permission to embed a badge on a third-party web site. Further, a member may embed the badge 410 in a plurality of third-party web sites, with each of the badges being dynamically updated each time the member updates their web-based social network profile 100 (FIG. 1). For example, if the member changes their status on their web-based social network profile 100, each of the badges 410 appearing on the plurality of third-party web sites will be dynamically updated to reflect the member's new status.

In a further embodiment, a computer user viewing the badge 410 on the third party web site 500 may activate a link on or within the badge 410 to be automatically directed to the member's social network profile 100. In an alternative embodiment, the computer user may be directed to a public profile that features a subset of the user information about the member that the member has selected and approved for public viewing.

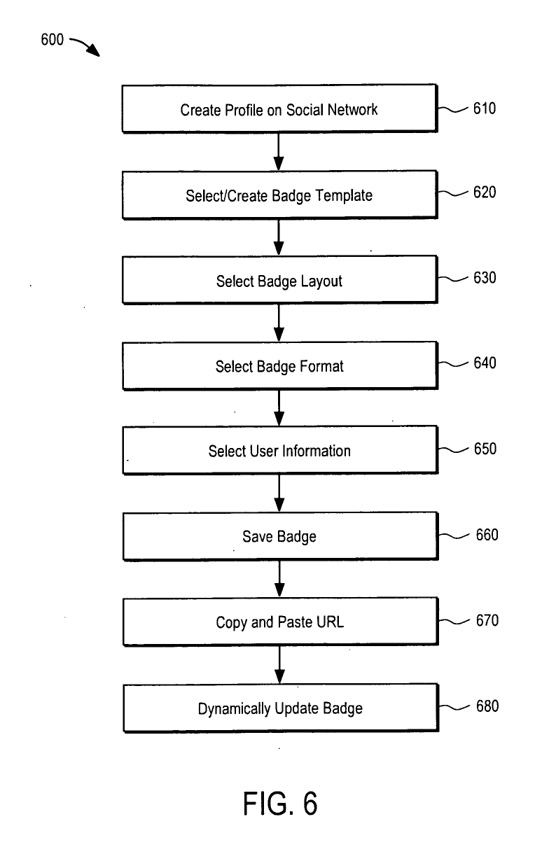

FIG. 6 is a flow chart of an exemplary process 600 for generating a web-based social network badge.

At step 610, a member of a web-based social network creates a profile. According to one exemplary embodiment, the web-based social network profile 100 (FIG. 1) includes various items of user information 110 (FIG. 1). User information in the social network profile 100 may include a member's name, profile picture, mobile number, email address, birthday, college, concentration or major, work information, and/or other information.

At step 620, the member selects or creates a badge template. According to one exemplary method, the member may access a screen such as badge selection screen 200 (FIG. 2) to select or create a badge template. The exemplary badge selection screen 200 includes a custom badge template selection 210 (FIG. 2), and pre-designed badge template selections 220 (FIG. 2). The member may use the pre-designed badge template selections 220 to select a badge template such as a photo badge template, a signature badge template and/or a blog badge template.

At step 630, the member selects a badge layout. In one embodiment, layout selections such as those shown at layout selections 320 (FIG. 3) allow the member to horizontally or vertically arrange information appearing on a badge such as badge 410 (FIG. 4). For example, if the member selects to horizontally arrange information appearing on the badge 410, the badge preview 310 (FIG. 3) may display the badge with the profile picture horizontally aligned next to the text information as illustrated in the exemplary badge preview 310 shown in FIG. 3.

At step 640, the member selects a badge format. For example, the format selections shown as format selections 330 (FIG. 3) allow the member to select whether his or her badge 410 will appear on a third party web site as an image or in javascript format. The image format is compatible with a wide variety of third party web sites. The javascript format works on fewer third party web sites, but may allow for the generation of a badge with a number of hyperlinks and the like that facilitate more opportunities for a user viewing the badge to interact with the badge.

At step 650, the member selects user information to be displayed on a badge, such as badge 410. According to one exemplary embodiment, an items selection feature such as items selection 340 (FIG. 3) may be used by a member to select various items of user information from the web-based social network profile 100 to appear on the badge 410. For example, the member may use the items selection 340 to include the member's profile picture on the badge 410. Additionally, a dynamic script accesses the selected user information and renders it for display on the badge preview 310.

At step 660, the member saves the badge. For example, the member may use the format save selection shown as format save selection 350 (FIG. 3) to save the badge 410.

At step 670, the member copies and pastes a URL such as URL 420 (FIG. 4) onto a third party web site. According to various exemplary methods, a member may use a URL such as URL 420 to embed the badge 410 as an image-based display on a third-party web site such as third-party web site 500 (FIG. 5). In a further embodiment, a computer user viewing the badge on the third party web site may activate a link on or within the badge to be automatically directed to the member's social network profile. In an alternative embodiment, the computer user may be directed to a public profile that features a subset of user information about the member that the member has selected and approved for public viewing.

At step 680, the badge is dynamically updated when the member updates his or her profile. For example, if the member changes the email address on his or her web-based social network profile, the badge will be dynamically updated to reflect the new email address.

While various embodiments have been described above, it should be understood that they have been presented by way of example only, and not limitation. Thus, the breadth and scope of a preferred embodiment should not be limited by any of the above-described exemplary embodiments.

1. A system for generating a web-based social network badge for display on a third-party web site, the system comprising:
a memory for storing:
a profile of user information for a user of the web-based social network;
a template for designating a format for the badge and selecting items of user information from the profile to appear on the badge; and
a badge including the selected items; and
a computer processor configured to:
access the user information from the profile;
create the badge based at least in part on the designated format and template item selections in the template; and
transmit the location in the memory of the badge to the third-party web site.

2. The system of claim 1, the profile configured to dynamically update the badge when a user updates the user information.

3. The system of claim 2, the badge on the third-party web site configured to include a link to the profile stored on the server for the web-based social network.

4. The system of claim 2, the badge on the third-party web site configured to include a link to a public profile.

5. The system of claim 2, the badge appearing on a plurality of third-party web sites.

6. The system of claim 5, the user information including a name.

7. The system of claim 6, the user information including a photograph.

8. The system of claim 7, the user information including a status.

9. A method for generating a web-based social network badge for display on a third-party web site, the method comprising:
storing a profile on a server for the web-based social network, the profile including user information;
receiving a selection of an item of user information from the profile;
accessing and rendering the selected user information as a badge; and
providing a URL for embedding the badge as an image-based display on the third-party web site.

10. The method of claim 9, further comprising dynamically updating the badge in response to a user updating the user information on the profile.

11. The method of claim 10, further comprising including in the badge a link to the profile stored on the server for the web-based social network.

12. The method of claim 10, further comprising including a link to a public profile on the badge.

13. The method of claim 10, further comprising displaying the badge on a plurality of third-party web sites.

14. The method of claim 13, wherein the user information on the badge includes a name.

15. The method of claim 14, wherein the user information on the badge includes a photograph.

16. The method of claim 15, wherein the user information on the badge includes a status.

17. A computer readable medium having embedded thereon a program, the program being executable by a processor for performing a method for generating a web-based social network badge for display on a third-party web site, the method comprising:
storing a profile on a server for the web-based social network, the profile including user information;
receiving a selection of an item of information from the profile;
accessing and rendering the selected information as a badge; and
providing a URL for embedding the badge as an image-based display on the third-party web site.

18. The method of claim 17, further comprising dynamically updating the badge in response to a user updating the user information on the profile.

19. The method of claim 17, further comprising including in the badge a link to the profile stored on the server for the web-based social network.

20. The method of claim 17, further comprising including a link to a public profile on the badge.
